(19) United States
(12) Patent Application Publication
(10) Pub. No.: US 2016/0013653 A1
(43) Pub. Date: Jan. 14, 2016

(54) CONVERTER STATION WITH DIODE RECTIFIER

(71) Applicant: SIEMENS AKTIENGESELLSCHAFT, MUENCHEN (DE)

(72) Inventors: JOERG DORN, BUTTENHEIM (DE); DOMINIK ERGIN, BAIERSDORF (DE); THOMAS HAMMER, SCHWABACH (DE); HANS-JOACHIM KNAAK, ERLANGEN (DE); PETER MENKE, OBERFUELLBACH (DE); JESPER MOELLER, ESBJERG (DK); ROLAND SCHUSTER, ERLANGEN (DE); HENRIK STIESDAL, ODENSE C (DK); JAN THISTED, TJELE (DK)

(21) Appl. No.: 14/771,266

(22) PCT Filed: Feb. 28, 2013
(86) PCT No.: PCT/EP2013/054070

§ 371 Date: Aug. 28, 2015

(51) Int. Cl. H02J 3/38; H02M 5/42

(52) U.S. Cl. CPC H02J 3/386; H02M 5/42

(57) ABSTRACT

A converter station for the transmission of electrical power includes a converter with a DC connection terminal and an AC connection terminal, and at least one transformer connected to the AC connection terminal. In order to render the converter station as cost-effective as possible, the station is distributed over at least two independent supporting structures.

The invention relates to a converter station for transmitting electrical power, having a converter, which has a DC-voltage connection and an AC-voltage connection, and at least one transformer, which is connected to the AC-voltage connection.

A converter station such as this is known, for example, from the article by S. Bernal-Perez et al., “Wind power plant control for the connection to multiterminal HVdc links”, IEEE, 2012, page 2873. That document discloses an installation in which a diode rectifier is connected on the DC-voltage side to a DC-voltage intermediate circuit. The DC-voltage intermediate circuit extends between two voltage source converters (VSC). The diode rectifier is connected to a wind farm via transformers and an AC-voltage grid. Furthermore, filter units, which are arranged on the AC-voltage side of the converter, are disclosed. On the DC-voltage side, a smoothing inductor is used to smooth the direct current generated by the diode rectifier.

The connection of wind farms erected in the sea to a supply grid on land is generally done with direct current in the case of large transmission paths. For this reason, in practice, a converter is at present accommodated on an open-sea platform which is erected in the vicinity of the wind farm in the sea. Said converter in the sea is connected via an AC-voltage grid to the wind farm, wherein a DC-voltage connection extends from the DC-voltage connection thereof to a converter on land. However, the erection of such converters in the sea is cost-intensive owing to the still large weight and large volume of the converters.

The problem addressed by the invention is therefore to provide a converter station of the type mentioned at the outset which is as inexpensive as possible.

Said problem is solved within the context of the invention in that the converter station is arranged in a manner distributed on at least two support structures which are erected independently of one another.

According to the invention, the converter station is no longer arranged on a single support structure; rather, the weight of the converter station is distributed on various support structures. Therefore, within the context of the invention, it is possible to dispense with the very expensive platforms which are usual today and, instead, support structures are used which, for example, are also used to support wind turbines. The distributed arrangement of the converter station according to the invention on comparatively inexpensive support structures is particularly advantageous in the case of a converter which is configured as a diode rectifier. The diode rectifier has a significantly lower weight in comparison with the self-commutated converters used up to now for connecting wind farms. This also applies in a restricted manner to a thyristor converter which is populated with current valves in the form of thyristors.

The converter station according to the invention may have, for example, a converter which is held by an individual, that is to say separate, support structure. Further components are not held on said support structure. In this case, the converter forms at least a six-pulse bridge with its current or voltage valves. One of the DC-voltage terminals of said six-pulse bridge is connected, for example, to the ground potential. The other DC-voltage terminal is then, for example, connected via a single-pole DC-voltage connection to a converter on land. It is also possible to configure the converter as a twelve-pulse bridge known from high-voltage direct-current transmission. The twelve-pulse bridge has two six-pulse bridges which are connected in series on the DC-voltage side. The connection point thereof is generally at ground potential. Each six-pulse bridge is connected, for example, via a separate transformer to an AC-voltage grid. The windings of the two transformers are connected to one another in a different manner, with the result that a different phase shift occurs at the transformers during transmission. Of course, the converter station may also have two six-pulse bridges which each have one terminal at ground potential.

The configuration of the converter is, in principle, arbitrary within the context of the invention. By way of example, the converter is a self-commutated converter, for instance a voltage source converter (VSC). The use of a modular multi-level converter is also possible within the context of the invention. Of course, the converter may also be an externally commutated converter the converter valves of which have thyristors.

According to a first variant of the invention, the converter and at least one of the transformers are held on different support structures. This separation has proven to be particularly expedient with respect to the distribution of weight.

According to a preferred variant of the invention, the support structures can be arranged in the sea or in a lake, wherein at least one support structure is a wind-turbine support structure which is dimensioned to hold a wind turbine. In other words, according to this variant of the invention, support structures which also serve or can also serve to hold wind turbines are used. With respect to their dimensioning, the materials used and the material strengths thereof, they are designed to hold masses which correspond to the mass of a wind turbine which is customary on the market. Such usual support structures for holding wind turbines, that is to say wind-turbine support structures, are known to a person skilled in the art under the terms mono-pile, tri-pile, tripod, jacket, gravity foundation, floating support structure, or the like. Exemplary embodiments thereof are specified below with reference to the drawing. Wind-turbine support structures are expedient in production in comparison with open-sea platforms. In this case, within the context of the invention, it is not ruled out that other components which are not components of the converter station are also held by the respective support structure. According to the invention, parts of the converter station may thus also be arranged on a support structure which additionally supports or holds a wind turbine. Within the context of the invention, the components of the converter station may also be directly mounted on a tower of the support frame of the wind turbine.

Expediently, the converter has a plurality of DC-voltage side series-connected or parallel-connected partial converters. Using said partial converters, the converter can be easily scaled and can thus easily be adapted to the respectively present current or voltage requirements. In this case, each partial converter may be arranged on a separate support structure which is assigned to said partial converter alone, for example a mono-pile. Of course, a plurality of partial converters may also be held on a support structure.

According to a further development which is expedient in relation hereto, each partial converter is connected on the AC-voltage side to a partial transformer, wherein said partial converter and said partial transformer are arranged in a common partial encapsulation housing. According to said advantageous further development, components which are assigned, for example, to a string of a wind farm may be generated, wherein the string is connected to a number of wind turbines. The encapsulation housing may be arranged in the sea in a simple manner, for example on the support structure of a wind turbine.

Expediently, each partial converter has two DC-voltage terminals which can be bypassed by means of a bypass switch. According to said advantageous further development, a partial converter station, which comprises by way of example a partial converter and a partial transformer, may be bypassed, for example in the event of a fault. If the partial converter station is connected to a section of a wind farm, for example to a string of a wind farm, said section may also be bypassed in this way. This is advantageous since the faults may be present both in the respective component and the string or branch of the AC-voltage grid connected to the component.

Expediently, each partial converter forms a six-pulse bridge or a twelve-pulse bridge.

Expediently, a filter unit is provided on the AC-voltage side of the converter. The filter unit is used to compensate reactive power and to filter out harmonics of the fundamental harmonic, which may occur during normal operation of the converter. The filter unit may also comprise wind turbines or consist exclusively of wind turbines.

Expediently, each partial converter is connected on the DC-voltage side to a partial smoothing inductor. The partial smoothing inductor is used to smooth the direct current. This is particularly expedient if the partial converters are at least partially configured as partial diode rectifiers.

In the case of a preferred configuration of the invention, the partial converters are at least partially partial diode rectifiers or thyristor partial converters, the current valves of which have a series circuit composed of diodes or of thyristors. The partial diode rectifier, which again may form a six-pulse or twelve-pulse bridge, is particularly light in comparison to the self-commutated partial converter and causes fewer losses. The thyristor partial converter forms current valves, which are actively switched on, therefore, during an ignition impulse but may not be switched off. However, thyristor current valves are robust and inexpensive.

Advantageously, the converter is a diode rectifier. As has already been mentioned, the diode rectifier with its passive power semiconductors which are not actuable is light and has low losses in comparison with a converter with converters that can be switched on and off. However, within the context of the invention, the converter may also be a self-commutated converter, for example a voltage source converter (VSC) and, in particular, a modular multi-level converter. Such converters have power semiconductor switches which can be switched on and off, such as IGBTs, GTOs, IGCTs, or the like.

If the converter is a diode rectifier, it is expedient that the diode rectifier is connected on the DC-voltage side to a smoothing inductor.

Expediently, power supply means for supplying an AC-voltage grid connected to the converter station are provided. The power supply means cater to the circumstances in which a diode rectifier allows a power transmission in only one direction. In the case of a wind-farm connection, to which the converter station according to the invention is particularly suited, it is often necessary, however, to supply the AC-voltage grid connected to the converter station with electrical power. By way of example, the wind turbines of the wind farm can be set up using said electrical energy and the rotor blades can be adjusted to the respectively required angle. The power supply means comprise, for example, a diesel engine which drives a generator, wherein the generator generates the required electrical power which is fed into the AC-voltage grid connected to the wind farm.

Advantageously, the power supply means are configured such that a diesel engine can be dispensed with, however, since the diesel engine requires a lot of maintenance and must be continuously supplied with diesel. In particular, in the event that the converter station according to the invention is situated in the sea, the fuel supply in the event of wind or storms is difficult. For this reason, within the context of the invention, it is expedient to provide power supply means by which the power can be supplied from a supply grid on land or an adjacent AC-voltage grid in the sea. Such power supply means comprise a power supply line which extends at least partially through the water and, for example, is an AC-voltage line with a voltage in the range from 50 to 70 kV.

According to a configuration of the invention which deviates therefrom, the power supply means comprise a partial converter which is connected in series with partial diode rectifiers of the converter on the DC-voltage side. It is possible using the partial converter to use the DC-voltage connection through which the converter station is connected to the power supply grid on land to also supply the power flow in the opposite direction, that is to say from land to the wind farm. In this connection, of course, it is expedient if the partial diode rectifiers, as mentioned above, are equipped with a bypass switch by means of which the bypassing of the partial diode rectifier in the series circuit is enabled, with the result that the power from a converter on land is provided by the DC-voltage connection and can be converted from the partial converter or converters into AC voltage. The AC voltage that is generated is then used for the power supply of a connected wind farm.

Expediently, the transformer is connected to a switchgear assembly. The switchgear assembly is, for example, a gas-insulated switchgear assembly, wherein a corresponding bushing between the switchgear assembly and the transformer which is stored, for example, in oil is provided. As has already been mentioned above, within the context of the invention, it is also possible to use a plurality of transformers. This also applies to the switchgear assembly.

The switchgear assembly is expediently connectable via an AC-voltage line to a coupling-in component which is connected to a power supply grid on land or an AC-voltage grid in the sea.

Advantageously, the transformer and the converter are arranged in an insulating material. The term insulating material is intended to comprise, within the context of the invention, all gases and liquids and solids which have improved insulation properties compared to atmospheric air.

Owing to the improved insulation properties, the individual components of the converter which are at different levels of electrical potential can be arranged at a shorter distance with respect to one another without voltage flashovers occurring. In particular, a diode rectifier with its passive and non-actuable power semiconductors can be arranged without problems in an insulating material. This also applies to an externally commutated converter equipped with thyristors. The insulating material must only be removed in the event of maintenance. For this purpose, for example, inlet and outlet means, via which the insulating material can escape or be poured in, are provided on an encapsulation housing in which the converter is arranged.

According to a preferred configuration of the invention, the converter and the transformer are each arranged in an encapsulation housing, wherein the encapsulation housings are connected to one another. In this way, said components may be electrically connected to one another without elaborate bushings having to be used which transfer a conductor at a high-voltage potential from one insulating-material environment into another insulating-material environment or into an air atmosphere. The encapsulation, which is generally at ground potential, of the components of the converter station moreover protects said components against damaging environmental influences which may cause damage, in particular when the converter station is erected in the sea or in a lake.

Advantageously, at least one encapsulation housing is provided in which at least a part of the converter and at least a part of the transformer are arranged together, wherein the encapsulation housing is filled with the insulating material. According to this advantageous further development of the invention, an encapsulation housing filled with insulating material is provided, in which the (partial) converter and the (partial) transformer are at least partially arranged together. In this way, the converter station may be configured to be even more compact. Of course, the wiring networks of the converter are also housed in the encapsulation housing or housings. The encapsulation housing or housings are expediently at ground potential.

The insulating material may, in principle, be gaseous, liquid or solid. Expediently, the protective gases, such as sulfur hexafluoride or the like, known in energy transmission and distribution are used. However, particular advantages emerge if a liquid, for instance an expedient insulating oil, is used as insulating material. In addition to insulation, the oil provides cooling.

Further expedient configurations and advantages of the invention are the subject matter of the following description of exemplary embodiments of the invention with reference to the figures of the drawing, wherein identical reference signs refer to identically acting components and wherein

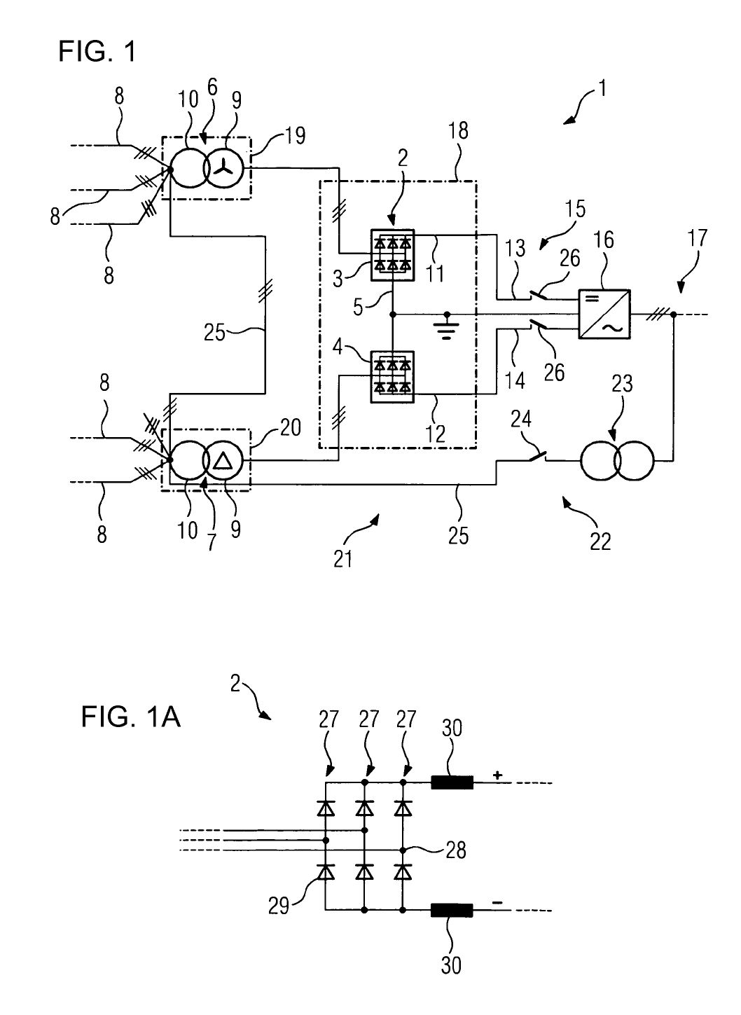

FIG. 1 schematically illustrates an exemplary embodiment of the converter station according to the invention,

FIG. 1a schematically illustrates the diode rectifier in detail,

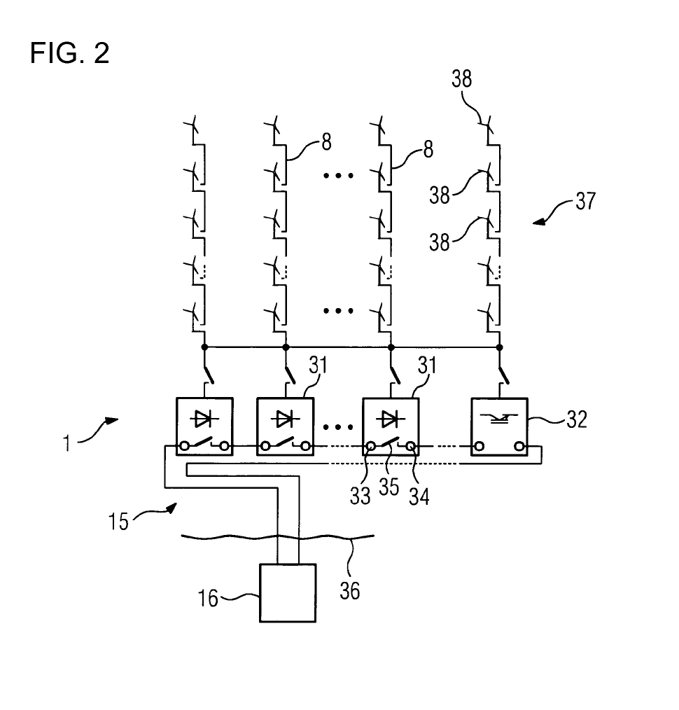

FIG. 2 schematically illustrates a further exemplary embodiment of a converter station according to the invention, which connects a wind farm arranged in the sea to a converter on land,

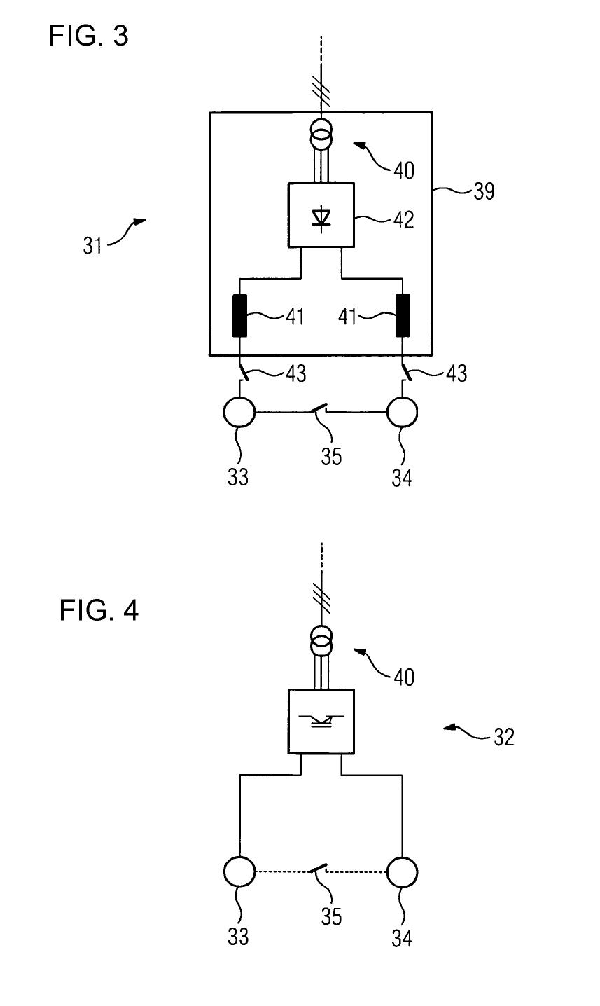

FIG. 3 schematically illustrates an exemplary embodiment of a partial converter station with partial diode rectifier, partial smoothing inductor and partial transformer in a common encapsulation housing,

FIG. 4 schematically illustrates an exemplary embodiment of a partial converter with a partial transformer,

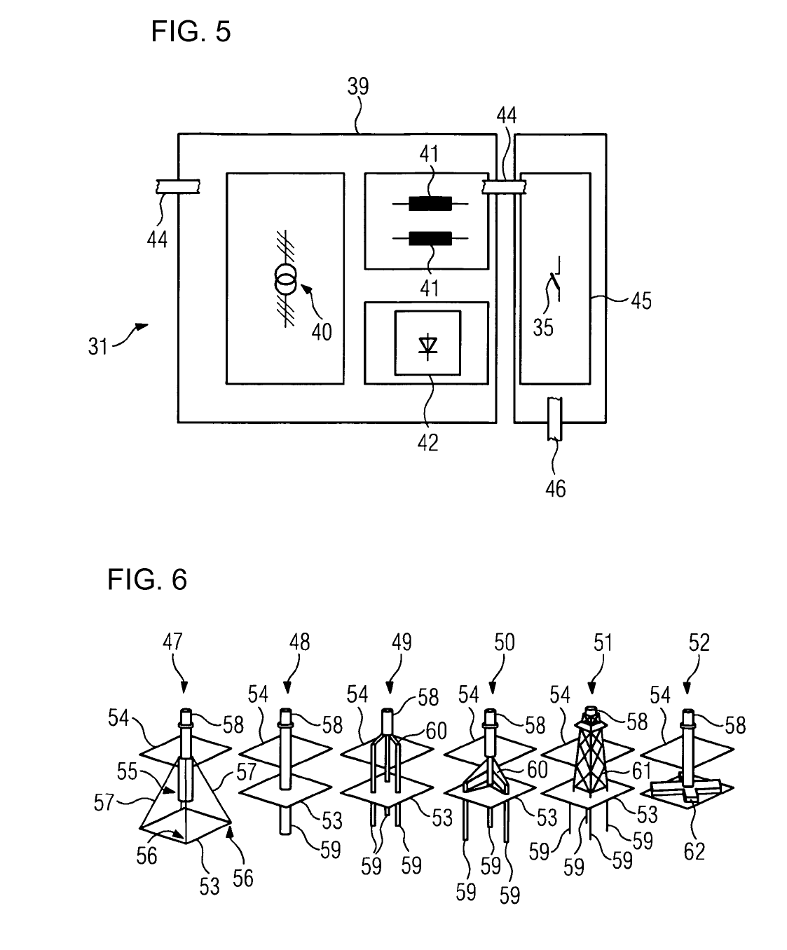

FIG. 5 schematically illustrates the partial converter station according to FIG. 3 in a lateral view,

FIG. 6 schematically illustrates a series of wind-turbine support structures used at the present time, and

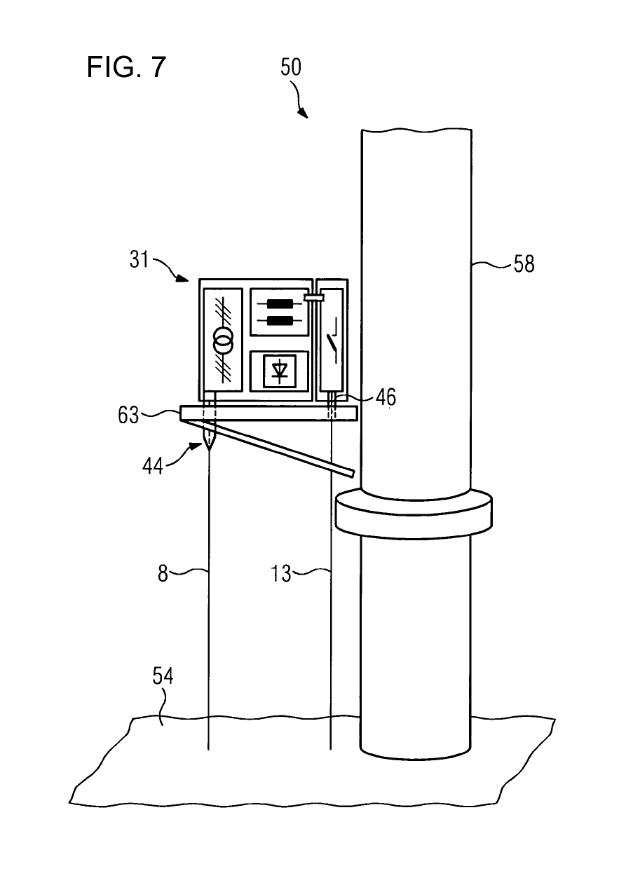

FIG. 7 schematically illustrates a wind-turbine support structure to which the partial converter station according to FIG. 5 is fastened.

FIG. 1 shows an exemplary embodiment of the converter station 1 according to the invention, which comprises a diode rectifier 2. The diode rectifier 2 forms a so-called twelve-pulse bridge which comprises two six-pulse bridges 3 and 4 which are each connected to one another at in each case one of their DC-voltage terminals by means of a grounded connection line 5 and in each case connected to various sections or strings 8 of an AC-voltage grid via a transformer 6 or 7. The transformers 6, 7 each have a primary winding 9 and a secondary winding 10. The primary winding 9, which is electrically connected to the AC-voltage connection of the six-pulse bridge 3, of the first transformer 6 forms a star point. In contrast, the primary winding 9 of the second transformer 7 is present as a delta circuit. This leads to a different phase shift in the case of the AC voltages transmitted thereby. Of course, it is possible—within the context of the invention—for each of the two six-pulse bridges 3, 4 to also be grounded at their DC-voltage terminals independently of the other six-pulse bridge. Even if the diode rectifier 2 has only one six-pulse bridge, said six-pulse bridge can be connected at a DC-voltage terminal to the ground potential, with the result that a so-called monopole is formed.

In the case of the diode rectifier 2 illustrated in FIG. 1, each of the six-pulse bridges 3 and 4, respectively, has a DC-voltage connection terminal 11 or 12, which is connected in each case to a pole 13 or 14 of a DC-voltage connection 15. A smoothing inductor which is not illustrated in the figures is arranged in each pole 13 or 14. The diode rectifier 2 is connected to a converter 16 erected on land and close to the coast by the DC-voltage connection 15, wherein the converter 16 on land has an AC-voltage connection by which said converter is connected to a power supply grid 17 on land, which power supply grid is illustrated only schematically in the figures. The power supply grid 17 is an AC-voltage grid.

The diode rectifier 2 is arranged on a support structure 18, which is arranged in the sea approximately 50 to 400 km from the coast. In a particularly advantageous embodiment, the support structures and foundations used in the respective wind farm as support structure 18 or the components are fastened directly to the tower of a wind turbine. The transformer 6 is arranged on a corresponding support structure 19 and the transformer 7 on a support structure 20. The support structures 18, 19, 20 are therefore particularly inexpensive. As has already been mentioned above, the converter station arranged in the sea is used to transmit power generated by the wind farm into the DC-voltage connection 15.

Since the diode rectifier 2 is set up to transmit power in only one direction, namely from the transformer 6 to the converter 16 on land, the energy required by the wind farm in the event of no wind must be provided to the wind farm in another way. For this purpose, energy transmission means 21 which have a coupling-in component 22 which in this case consists of a coupling-in transformer 23 and a mechanical switch 24 are used. The coupling-in component 22 is connected via an AC-voltage line 25 and the switchgear assembly which is not illustrated in the figures to the strings 8 of the AC-voltage grid. In this case, the coupling-in component 22 is connected to the power supply grid 17 via the transformer 25. The transformer 25 supplies an expedient AC voltage in the order of magnitude between 50 and 70 kV. In this way, the wind farm can be supplied with energy from land.

The construction of the six-pulse bridge 3 is illustrated in more detail in FIG. 1a. It can be seen that the six-pulse bridge 3 has three phase modules 27 the number of which corresponds to the number of phases of the AC-voltage grid 8 to which the respective transformer 6, 7 is connected. Each phase module 27 has two mutually oppositely polarizable DC-voltage connections or DC-voltage terminals, which are marked with a plus sign and minus sign. Furthermore, each phase module 27 has an AC-voltage connection 28. In each case, a diode valve 29 extends between the AC-voltage connection 28 and each of the DC-voltage connections, with the result that each phase module 27 has two diode valves 29. The diode valves 29 comprise a series circuit composed of diodes the number of which is in each case dependent on the present voltage. On the DC-voltage side of the diode rectifier 2, the smoothing inductors 30 are illustrated schematically and without encapsulation housing.

FIG. 2 shows another exemplary embodiment of the converter station 1 according to the invention, which is composed of partial converter stations 31, wherein each partial converter station 31 has, in addition to a partial diode rectifier, a partial transformer which is not illustrated in the figures and a partial smoothing inductor which is likewise not illustrated in the figures. The partial converter stations 31 are connected to one another in series on the DC-voltage side. Moreover, a partial converter 32 can be seen in said series circuit. Each partial converter station 31 has a first DC-voltage connection terminal 33 and a second DC-voltage connection terminal 34, which may be connected to one another by means of a bypass switch 35. Thus, bypassing, for example, of a faulty partial converter station 31 is enabled by means of the bypass switch 35.

As has already been mentioned, the converter station 1 is distributed on a plurality of support structures, approximately 100 km from a coast 36 in the sea, wherein a converter 16 on land is connected via a DC-voltage connection 15 to the converter station 1. It can be seen that each partial converter station 31 is connected to a string 8 of an AC-voltage grid 7 which is used to connect a wind farm 37 to the converter station 1. The wind farm 37 consists of a multiplicity of wind turbines 38.

Even in the event of no wind, the wind farm 37 requires energy. This is provided thereto using the partial converter 32. For this purpose, for example, all of the partial diode rectifiers 31 are bypassed by closing the respective bypass switch 35, with the result that the partial converter 32 is directly connected to the converter 16 on land, which is a modular multi-level converter, for example. Said modular multi-level converter is connected to a power supply grid which is not illustrated in the figures and feeds the necessary power into the partial converter 32, which provides said power on the AC-voltage side for the wind farm 37.

FIG. 3 shows the partial converter station 31 in more detail. It can be seen that the partial converter station 31 has a partial encapsulation housing 39 in which two partial smoothing inductors 41, a partial diode rectifier 42 and a partial transformer 40 are arranged together. The partial diode rectifier forms a six-pulse bridge, for example. The partial encapsulation housing 39 is filled with an insulating oil. Outside of the partial encapsulation housing 39, mechanical DC-voltage switches 43 can be seen, by means of which the respective pole is connectable to the bypass switch 35.

FIG. 4 shows the partial converter 32, which is not arranged in a separate encapsulation housing, in more detail. The partial converter 32 does not have any smoothing inductors on the DC-voltage side. These are unnecessary in the case of a controlled or self-commutated partial converter. In addition, the partial converter 32 can be bypassed using a bypass switch 35 on the DC-voltage side.

FIG. 5 shows a schematic lateral view of the partial converter station 31. It can be seen that the partial transformer 40, the partial smoothing inductors 41 and the partial diode rectifier 42 are arranged in a common encapsulation housing 39 which is filled with oil. Furthermore, bushings 44 can be seen with which high-voltage conductors are transferred from an oil insulation into a protective gas insulation, wherein they extend through one or more walls of the respective encapsulation housing, which walls are at ground potential. Moreover, it can be seen that the bypass switch 35 is likewise arranged in an encapsulation housing 45 which is filled, however, with a protective gas, in this case sulfur hexafluoride. The bushing 46 enables a cable to be connected to the housing 45 filled with protective gas.

FIG. 6 shows exemplary embodiments of wind-turbine support structures 47 to 52, which are set up to support parts of the converter station 1. In this case, the seafloor is provided with the reference sign 53 and the surface of the water is provided with the reference sign 54.

The support structure 47 is a so-called floating support structure, wherein a freely floating buoyant body 55 is permanently anchored to the seafloor by an anchor 56 and rope 57. A tower or mast 58 is supported on the floating buoyant body 55 and set up to hold the wind turbine. The buoyant body 55 is adjusted in terms of its buoyancy forces to the intrinsic weight of the tower 58 and the weight of a wind turbine. The anchoring 56 on the seafloor 53 is done, for example, by driving piles into the seafloor. Provision is made of ballast bodies, departing from said driven piles, which lay freely on the seafloor and to which the ropes are fastened.

In the case of the support structure 48, only one driven pile has been driven into the seafloor 53, wherein the driven-in pile is extended by a tower or tower section 58. Again, parts of the converter station 1 can be fastened to the tower 58.

The support structure 49 differs from the support structure 48 in that three driven piles 59 have been driven into the seafloor. A space framework 60 can be seen above the surface 54 of the water on the three driven piles, said space framework being supported on all three driven piles. The tower or mast 58 projects perpendicularly from the space framework 60.

The support structure 50 differs from the support structure 49 in that the space framework 60 is tetrahedral and arranged below the surface 54 of the water.

The support structure 51 has a support framework 61 instead of a space framework, said support framework being supported on four driven piles 59 and extending both below and above the surface 54 of the water. Again, the tower or mast 58 of the wind turbine is supported on the support framework 61.

The support structure 52 has a stand foot 62 which lies on the seafloor 53. The mast or tower 58 extends directly from the stand foot 62.

FIG. 7 shows the fastening of the partial converter station 31 according to FIG. 5 to a tower 58 of the wind-turbine support structure 50 according to FIG. 6. It can be seen that a support platform 63 is placed on the tower or mast 58, on which support platform the partial converter station 31 according to FIG. 5 is supported. The bushing 44 arranged here in the base region of the partial converter station 31 enables the connection of an AC-voltage cable which corresponds to one of the strings 8 of the AC-voltage grid which connects the converter station 1 to the wind farm 37. A voltage of approximately 65 kV is applied to the string 8. In addition, a pole 13 of the DC-voltage connection 5 can be seen, which pole is at a DC-voltage potential between 200 and 400 kV with respect to the ground potential.

1-18. (canceled)

19. A converter station for transmitting electrical power, the converter station comprising:
a converter having a DC-voltage connection and an AC-voltage connection;
at least one transformer connected to said AC-voltage connection of said converter; and
at least two support structures erected independently of one another and supporting the converter station distributed over said at least two support structures.

20. The converter station according to claim 19, wherein said converter and at least one said transformer are disposed on mutually different support structures.

21. The converter station according to claim 19, wherein said support structures are disposed to project from a body of water and at least one of said support structures is a wind-turbine support structure configured and dimensioned to hold a wind turbine.

22. The converter station according to claim 19, wherein said converter has a plurality of DC-voltage side series-connected or parallel-connected partial converters, and wherein said partial converters are held at least partially on mutually different said support structures.

23. The converter station according to claim 22, wherein said at least one transformer comprises a plurality of partial transformers and each said partial converter is connected on an AC-voltage side to a respective partial transformer.

24. The converter station according to claim 23, which comprises a partial encapsulation housing commonly housing said partial converter and said partial transformer.

25. The converter station according to claim 22, wherein each partial converter has two DC-voltage terminals and a bypass switch is disposed to bridge said two DC-voltage terminals and to bypass said partial converter.

26. The converter station according to claim 22, wherein each said partial converter forms a six-pulse bridge.

27. The converter station according to claim 22, wherein each said partial converter forms a twelve-pulse bridge.

28. The converter station according to claim 19, which comprises a filter unit connected on an AC-voltage side of said converter.

29. The converter station according to claim 22, which comprises a partial smoothing converter connected to a DC-voltage side of each said partial converter.

30. The converter station according to claim 22, wherein said partial converters are at least partially partial diode rectifiers with current valves formed by a series circuit composed of diodes or thyristor partial converters with current valves formed by a series circuit composed of thyristors.

31. The converter station according to claim 19, wherein said converter is a diode rectifier.

32. The converter station according to claim 31, which comprises a partial smoothing inductor connected on a DC-voltage side to said diode rectifier.

33. The converter station according to claim 19, which comprises a power supply device for supplying an AC-voltage grid connected to the converter station with electrical power.

34. The converter station according to claim 33, wherein said power supply device comprises a partial converter connected in series with said partial diode rectifiers on the DC-voltage side.

35. The converter station according to claim 19, wherein each of said at least one transformer is connected to a switchgear assembly.

36. The converter station according to claim 35, wherein said switchgear assembly is connectable via an AC-voltage line to a coupling-in component that is connected to a power supply grid on land or an AC-voltage grid at sea.
